(19) United States
(12) Patent Application Publication
(10) Pub. No.: US 2006/0094602 A1
(43) Pub. Date: May 4, 2006

(54) Adjuvant composition

(76) Inventors: Robert William Killick, Mount Waverly (AU); Peter William Jones, Menzies Creek (AU); John David Morrison, Thomastown (AU); Andrew Robert Killick, Richmond (AU); Peter Ronald Wrigley, Blackburn (AU)

Correspondence Address: Gregory J Lavorgna;Drinker Biddle & Reath, Intellectual Property Group, One Logan 18th & Cherry Streets, Philadelphia, PA, 19103-6996, US

(21) Appl. No.: 10/513,948

(22) PCT Filed: May 9, 2003
(86) PCT No.: PCT/AU03/00553

§ 371 Date: Aug. 4, 2005

(30) Foreign Application Priority Data
May 10, 2002 (AU) PS 2228

(51) Int. Cl. A01N 25/16; A01N 25/04

(52) U.S. Cl. 504/365; 424/405

(57) ABSTRACT

According to the invention, there is provided a composition having pH adjusting capabilities for use with water to be used for spraying an agrochemical, said composition comprising: (a) not more than 98% by weight of the total composition of one or more carriers selected from the group consisting of lipophilic solvents selected from the group consisting of mineral oils, vegetable oils or alkyl esters of fatty acids and mixtures thereof; surfactants; and mixtures thereof; and (b) a buffering system comprising: (i) 0.1 to 10% by weight of the total composition of boric acid; (ii) 0.1 to 50% by weight of the total composition of an organic carboxylic acid containing up to six carbon atoms; and (iii) 0.2 to 50% by weight of the total composition of an organic amine to form complexes with (i) and (ii) which are soluble in the carrier.

### FIELD OF THE INVENTION

The invention relates to an adjuvant composition for use with agrochemicals. More particularly the invention relates to an adjuvant composition having pH adjusting characteristics.

### BACKGROUND OF THE INVENTION

In this specification, where a document, act or item of knowledge is referred to or discussed, this reference or discussion is not an admission that the document, act or item of knowledge or any combination thereof was at the priority date part of common general knowledge; or known to be relevant to an attempt to solve any problem with which this specification is concerned.

There is a growing trend to produce adjuvants to improve the efficacy of agrochemicals, including herbicides. For example, farmers add adjuvants which may contain lipophilic solvents, surfactants, plant nutrients or water conditioners to tank mixes of agrochemicals in order to improve their efficacy. Most pesticide applications benefit by the addition of one or more of the adjuvant types above.

One of the factors which farmers must consider when using agrochemicals is the pH of the water being used as the carrier for the tank mix. High pH water commonly comes from aquifers that flow through basic minerals and ground water emitted from alkaline soils. Low pH water can come from minerals, acidic soils and more recently from surface waters that result from acid rain.

Some agrochemicals are sensitive to the pH of the overall composition and may actually be substantially degraded if the pH is outside a certain range. High pH water may cause alkaline hydrolysis resulting in the degradation of the chemical. Low pH water can also cause chemicals to breakdown by acid hydrolysis. The organophosphate insecticides are known to be sensitive to high pH as is dimethoate whilst the sulphonylurea herbicides break down more quickly at low pH. Because many pesticides can be degraded by alkaline or acidic conditions, it is common for pesticide manufacturers to recommend a preferred pH range usually in the neutral to slightly acidic range 5 to 7, however some agrochemicals may have a preferred pH outside of this range. In addition to the problem of chemical degradation associated with high or low pH, uptake of foliar herbicides can be affected by the pH of the spray solution applied.

Inorganic buffers are available and will easily adjust the pH of a spray solution into the required range but do not provide the other adjuvant effects which are often necessary to optimize pesticide applications. The use of inorganic buffers will usually require additional adjuvants to be used for pesticide applications to obtain optimum results.

As a result, there have been attempts to produce adjuvants which will enhance the effectiveness of pH sensitive agrochemicals by incorporating buffering components with other adjuvant components (eg lipophilic solvents and/or surfactants). Previous attempts to address this issue by formulating adjuvant compositions which modify pH have assumed that the water being used would be alkaline and therefore merely added an acidifying agent such as propionic acid or phosphate esters such as an alkylaryl polyethoxy phosphate ester. As a result, these compositions cannot be used with neutral or acidic waters since the resultant pH may be too low for the agrochemical to be effective.

There is thus a need for an adjuvant composition which can be used to facilitate use of an agrochemical in water that has a low pH, a neutral pH or a high pH.

### SUMMARY OF THE INVENTION

It has surprisingly been found that the combination of C1 to C6 organic carboxylic acids, boric acid and organic amines can be readily formulated with lipophilic solvents and/or surfactants. This enables the preparation of adjuvant compositions having pH adjusting capabilities as well as pH adjusting compositions having other adjuvant characteristics such as wetting, penetration, spreading and solubility. Both types of compositions are able to enhance the efficacy of an agrochemical when mixed with this pH adjusted water.

According to a first aspect of the invention an adjuvant composition having pH adjusting capabilities for use with water to be used for spraying an agrochemical is provided, said adjuvant composition comprising:
(a) 40 to 98% by weight of the total adjuvant composition of one or more carriers selected from the group consisting of lipophilic solvents selected from the group consisting of mineral oils, vegetable oils or alkyl esters of fatty acids and mixtures thereof; surfactants; and mixtures thereof; and
(b) 2 to 60% by weight of the total adjuvant composition of a buffering system comprising:
   (i) 0.1 to 10% by weight of the total adjuvant composition of boric acid;
   (ii) 0.1 to 10% by weight of the total adjuvant composition of an organic carboxylic acid containing up to six carbon atoms; and
   (iii) 0.2 to 50% by weight of the total adjuvant composition of an organic amine to form complexes with (i) and (ii) which are soluble in the carrier.

Preferably, the amount of boric acid is in the range from 0.5 to 5.0, more preferably 1.0 to 3.0. Preferably, the amount of organic carboxylic acid is in the range from 0.5 to 5.0, more preferably 1.0 to 3.0. Preferably, the amount of organic amine is in the range from 1 to 25.

According to a second aspect of the invention, there is provided a pH adjusting composition having other adjuvant properties for use with water to be used for spraying an agrochemical is provided, said pH adjusting composition comprising:
(a) 10 to 40% by weight of the total pH adjusting composition of one or more carriers selected from the group consisting of lipophilic solvents selected from the group consisting of mineral oils, vegetable oils or alkyl esters of fatty acids and mixtures thereof; surfactants; and mixtures thereof; and
(b) 60 to 90% by weight of the total pH adjusting composition of a buffering system comprising:
   (i) 0.1 to 10% by weight of the total pH adjusting composition of boric acid;
   (ii) 5 to 50% by weight of the total pH adjusting composition of an organic carboxylic acid containing up to six carbon atoms; and
   (iii) 0.2 to 50% by weight of the total pH adjusting composition of an organic amine to form complexes with (i) and (ii) which are soluble in the carrier.

Preferably, the amount of boric acid is in the range from 0.5 to 5.0, more preferably 1.0 to 3.0. Preferably, the amount of organic carboxylic acid is in the range 5 to 30. Preferably, the amount of organic amine is in the range from 1 to 25.

According to a third aspect of the invention, there is provided a method for adjusting the pH of water to be used for spraying an agrochemical, said method comprising the step of adding an adjuvant composition according to the first aspect of the invention or a pH adjusting composition according to the second aspect of the invention to the water.

In a preferred embodiment, the adjuvant composition and pH adjusting composition in use adjusts the pH of the water to be used for spraying an agrochemical to raise the pH of low pH water or lower the pH of high pH water to a pH in the range of from 3.5 to 9. Preferably, the pH is adjusted to within the range of from 5 to 8.

Some pesticide products may have a preferred pH at which they are known to be more stable or more efficacious. The adjuvant composition and pH adjusting composition can be prepared to adjust the pH of water toward a particular pH within the ranges specified by carefully selecting the proportions of acids (i) and (ii) and alkaline (iii) components. For example, a pH adjusting composition with 1.5% w/w boric acid, 25.5% w/w propionic acid and 9.4% w/w of oleylamidopropylamine will adjust the pH of water towards 4, whereas an adjuvant composition with boric acid 3.5% w/w, propionic acid 1.5% w/w and cocoamine 9.7% w/w will adjust the pH of water towards 8.5. The pH adjusting compositions having higher proportions of buffering system are more effective at adjusting pH than the adjuvant compositions according to the first aspect of the invention. However, the adjuvant compositions will be used when more effective other adjuvant properties such as wetting, spreading or penetration are desired. It will depend on the specific situation whether a composition according to either of the first or second aspects of the invention is used.

Suitable mineral oils are known to those skilled in the art and typically include aliphatic hydrocarbons with average carbon number from 15 to 30 or may be denoted by their viscosity with suitable examples being 60 to 150 second solvent neutral oils.

The vegetable oils are any suitable vegetable oils known to those skilled in the art including medium chain triglycerides and canola, corn, sunflower and soyabean oils.

If alkyl esters of fatty acids are used then a majority of unsaturated fatty acids are preferred. Without wishing to be bound by theory, unsaturated fatty acids are preferred because they are more effective as surface modifiers and remain as usable liquid at lower temperatures. There are innumerable variations of the esters of fatty acids which may be produced from the natural oils and fats such as lard, tallow and vegetable oils, such as canola, corn, sunflower and soyabean oils, or from specific blends produced by fatty acid manufacturers or from fatty acids produced by synthetic means. The alkyl moiety may be derived from simple alcohols such as methyl, ethyl, propyl or butyl alcohols.

The range of surfactants suitable for use as the carrier will be well known to those skilled in the art and may be selected from nonionic, cationic or anionic surfactants and should be chosen for either or both of the following purposes:
wetting and spreading. Surfactants are often used to enhance the wetting and spreading of pesticide on the target which in turn can increase the efficacy of the application
emulsification. Surfactants are necessary to emulsify lipophilic solvents into water when such solvents are used as adjuvants in aqueous spray applications. Adequate emulsification is necessary to distribute the solvent evenly enough to provide useful adjuvant effects.

Examples of suitable surfactants include, but are not limited to, sodium diisooctylsulphosuccinate, sulphated alcohol ethoxylates, alcohol ethoxylates, alkylaryl ethoxylates, fatty acid ethoxylates, fatty acid glycerol esters, fatty alkanolamides, fatty amine ethoxylates, fatty acid sorbitan esters, ethoxylated fatty acid sorbitan esters, alkyl polyglucosides, fatty amine oxides and fatty betaines.

The organic carboxylic acid containing up to six carbon atoms may be a simple carboxylic acid such as acetic or propionic acid or may contain other functionality such as hydroxyl, ether or additional carboxyl groups. Examples include, but are not limited to, malic, maleic, or citric acids.

Examples of suitable organic amines include, but are not limited to, alkanolamines, or primary or tertiary alkylamines such as fattyamines, dimethylalkylamines and alkylamidoalkyldimethylamines. Specific examples includes oleylamidopropylamine, cocoamine, oleylamine, triethanolamine, oleylamidoethanolamine, di(C10)methylamine, dimethylcocoamine and oleylpropylenediamine.

For adjuvant compositions and pH adjusting compositions where the carrier is a surfactant, then the organic amine may be an alkanolamine such as mono-, di-, or triethanolamine, which should provide adequate solubility of the buffering salt into the surfactant.

For adjuvant compositions and pH adjusting compositions where the carrier is primarily a lipophilic solvent, then the organic amine may be selected from primary amines or tertiary dimethylamines of the structure (CH₃)₂N—R wherein R contains an alkyl group of at least 8 carbon atoms and may contain other chemical moieties. For example, the tertiary dimethylamines may be selected from dimethylalkylamines or other substituted alkyldimethylamines such as alkylamidoalkyldimethylamines. Examples of such tertiary dimethylamines are dimethylcocoamine, oleylamidopropyldimethylamine and oleo adducts prepared from N.N-dimethylaminoethanol and N.N-dimethylethylenediamine. Other tertiary amines such as di(C10)methylamine may also be suitable.

In a preferred embodiment of the invention, the adjuvant composition and pH adjusting composition may further comprise other solvents which improve the physical characteristics of the formulation such as reduced viscosity or homogeneity over a wide temperature range. Examples of suitable other solvents include glycols such as glycerine, hexylene glycol or 1,3-butanediol, glycol ethers such as dipropyleneglycol monomethyl ether, simple alcohols such as ethanol or isopropanol or water.

According to a fourth aspect of the invention, a buffering system for use with water to be used for spraying an agrochemical is provided, said buffering system comprising
(a) 0.1 to 10% by weight of boric acid;
(b) 0.1 to 50% by weight of an organic carboxylic acid containing up to six carbon atoms; and
(c) 0.2 to 50% by weight of an organic amine to form complexes with (a) and (b).

According to a fifth aspect of the invention, there is provided a method for adjusting the pH of water to be used for spraying an agrochemical to a pH in the range of from 3.5 to 9 comprising the steps of:
(a) adding the water to a tank for mixing agrochemical compositions;
(b) adding to the tank, a buffering system comprising:
   (i) 0.1 to 10% by weight of boric acid;
   (ii) 0.1 to 50% by weight of an organic carboxylic acid containing up to six carbon atoms; and
   (iii) 0.2 to 50% by weight of an organic amine to form complexes with (i) and (ii); and
(c) adding one or more carriers selected from the group consisting of lipophilic solvents selected from the group consisting of mineral oils, vegetable oils or alkyl esters of fatty acids and mixtures thereof; surfactants; and mixtures thereof to the tank.

### EXAMPLES

The invention will now be further explained and illustrated by reference to the following non-limiting examples.

The following components are used in the examples:

| | |
|---|---|
| RoundUp CT | Commercial herbicide containing 450 g/L glyphosate as |
| | the isopropylamine salt ex Monsanto |
| BASTA | Commercial herbicide containing 200 g/L glufosinate- |
| | ammonium ex Aventis |
| LI-700* | Commercial adjuvant containing Soyal Phospholipids |
| | (355 g/L) and Propionic Acid (345 g/L) ex Nufarm |
| | *Data from manufacturer indicates that LI-700 at usage |
| | rates of 0.1-0.2% reduces pH of typical agricultural |
| | water to less than pH 4. |
| Acetic Acid | Ex Chem-Supply, Australia |
| glacial | |
| Armeen | Dimethylhydrogenated Tallowamine ex Akzo Chemicals |
| DMHTD | BV, Holland |
| BL8 | Alcohol ethoxylate ex Huntsman Surfactants, Australia |
| 1,3-butanediol | Ex Tiger Chemical Company, Australia |
| Boric Acid | Ex Quantum Chemicals |
| Canola Oil | Ex Australian Country Canola, Australia |
| DEANOL | 2-(Dimethylamino)ethanol ex Huntsman Australia |
| Dinoram O | Oleylpropylenediamine ex Ceca SA, France |
| DMC | Dimethylcocoamine ex Proctor & Gamble |
| Esterol 112 | Methyl esters of Canola Oil ex Victorian Chemical |
| | Company, Australia |
| Esterol 123 | Ethyl and methyl esters of Canola Oil ex Victorian |
| | Chemical Company, Australia |
| Esterol 263 | PEG 600 Dioleate ex Victorian Chemical Company, |
| | Australia |
| Esterol 272 | Glycerol Monooleate ex Victorian Chemical Company, |
| | Australia |
| Farmin C | Cocoamine ex Kao Corp, S. A. Spain |
| Glysolv DPM | Dipropylene Glycol Monomethyl Ether ex Huntsman |
| | Surfactants Australia |
| Noram O | Oleylamine ex Ceca SA, France |
| OAPA | Oleylamidopropylamine ex Victorian Chemical |
| | Company, Australia |
| Propar 12 | Paraffinic Mineral Oil - 70SN ex Caltex, Australia |
| Propionic Acid | Ex BASF |
| Radiamine | Di(C10)Methylamine ex Fina Chemicals, Belgium |
| 6310 | |
| TEA | Triethanolamine ex Union Carbide |
| Teric 17A3 | Alcohol ethoxylate ex Huntsman Surfactants, Australia |
| Teric 17M2 | N,N diethoxytallowamine ex Huntsman Surfactants, |
| | Australia |
| THT | Tetraethylenepentamine Dioleamide ex Victorian |
| | Chemical Company, Australia |
| Unisol 516 | Sodium Diisooctylsulphosuccinate 60% in aqueous |
| | ethanol ex Victorian Chemical Company, Australia |
| Vicamid 182 | Oleylamidoethylethanolamine ex Victorian Chemical |
| | Company, Australia |

The following Compositions were prepared according to the invention for use in the examples:

| Composition | Carrier (g) | Buffering System (g) |
|---|---|---|
| 1 | Lipophilic solvent: Canola oil (49.5) | Boric Acid (3.0) |
| | Surfactant: Esterol 272 (17.0); | Propionic Acid (1.0) |
| | Esterol 263 (5.0) | |
| | Other: 1,3 butanediol (5.9) | Organic Amine: OAPA (18.6) |
| 2 | Lipophilic solvent: Propar 12 (49.5) | Boric Acid (3.0) |
| | Surfactant: Esterol 272 (17.0); | Propionic Acid (1.0) |
| | Esterol 263 (5.0) | |
| | Other: 1,3 butanediol (5.9) | Organic Amine: OAPA (18.6) |
| 3 | Lipophilic solvent: Esterol 123 (60.1) | Boric Acid (3.0) |
| | Surfactant: Teric 17A3 (10.0); | Propionic Acid (1.0) |
| | Esterol 263 (5.0) | |
| | Other: 1,3 butanediol (5.9) | Organic Amine: DMC (15.0) |
| 4 | Surfactant: Unisol 516 (92.7) | Boric Acid (1.8) |
| | | Propionic Acid (1.8) |
| | | Organic Amine: TEA (3.7) |
| 5 | Surfactant: Unisol 516 (89.0) | Boric Acid (3.0) |
| | | Propionic Acid (4.0) |
| | | Organic Amine: TEA (4.0) |
| 6 | Lipophilic solvent: Esterol 123 (34.4) | Boric Acid (1.4) |
| | Surfactant: Unisol 516 (51.7) | Propionic Acid (1.4) |
| | Other Glysolv DPM (4.6); | Organic Amine: TEA (3.1) |
| | 1,3-butanediol (3.4) | |
| 7 | Lipophilic solvent: Canola oil (49.5) | Boric Acid (1.5) |
| | Surfactant: Esterol 272 (8.6); | Propionic Acid (25.5) |
| | Esterol 263 (2.5) | |
| | Other: 1,3-butanediol (3.0) | Organic Amine: OAPA (9.4) |
| 8 | Lipophilic solvent: Canola oil (50.0) | Boric Acid (3.3) |
| | Surfactant: Esterol 272 (23.3); | Propionic Acid (1.3) |
| | Esterol 263 (6.7) | |
| | Other: 1,3-butanediol (5.3) | Organic Amine: DMC (10.0) |
| 9 | Lipophilic solvent: Canola oil (50.0) | Boric Acid (3.0) |
| | Surfactant: Esterol 272 (21.2); | Propionic Acid (1.3) |
| | Esterol 263 (7.5) | |
| | Other: 1,3-butanediol (6.7) | Organic Amine: Noram O (10.3) |
| 10 | Lipophilic solvent: Canola oil (50.0) | Boric Acid (3.5) |
| | Surfactant: Esterol 272 (23.3); | Propionic Acid (1.5) |
| | Esterol 263 (6.7) | |
| | Other: 1,3-butanediol (5.3) | Organic Amine: Farmin C (9.7) |
| 11 | Lipophilic solvent: Canola oil (50.0) | Boric Acid (3.0) |
| | Surfactant: Esterol 272 (22.5); | Propionic Acid (1.2) |
| | Esterol 263 (7.5) | |
| | Other: 1,3-butanediol (5.3) | Organic Amine: Radiamine 6310 |
| | | (10.5) |
| 12 | Lipophilic solvent: Canola oil (50.0) | Boric Acid (2.5) |
| | Surfactant: Esterol 272 (23.3); | Propionic Acid (1.0) |
| | Esterol 263 (6.7) | |
| | Other: 1,3-butanediol (5.3) | Organic Amine: Teric 17M2 (11.2) |
| 13 | Lipophilic solvent: Canola oil (50.0) | Boric Acid (4.2) |
| | Surfactant: Esterol 272 (20.8); | Propionic Acid (1.8) |
| | Esterol 263 (7.8) | |
| | Other: 1,3-butanediol (6.7) | Organic Amine: Dinoram O (8.7) |
| 14 | Lipophilic solvent: Canola oil (50.0) | Boric Acid (2.8) |
| | Surfactant: Esterol 272 (20.8); | Propionic Acid (1.3) |
| | Esterol 263 (7.5) | |
| | Other: 1,3-butanediol (7.0) | Organic Amine: Armeen DMHTD |
| | | (10.5) |
| 15 | Lipophilic solvent: Canola oil (50.0) | Boric Acid (3.3) |
| | Surfactant: Esterol 272 (16.7); | Propionic Acid (1.3) |
| | Esterol 263 (6.7) | |
| | Other: 1,3-butanediol (5.3) | Organic Amine: THT (16.7) |
| 16 | Lipophilic solvent: Canola oil (50.0) | Boric Acid (3.3) |
| | Surfactant: Esterol 272 (16.7); | Propionic Acid (1.3) |
| | Esterol 263 (6.7) | |
| | Other: 1,3-butanediol (5.3) | Organic Amine: Vicamid 182 (16.7) |
| 17 | Lipophilic solvent: Esterol 123 (34.4) | Boric Acid (1.4) |
| | Surfactant: Unisol 516 (51.7) | Acetic Acid glacial (1.1) |
| | Other: Glysolv DPM (4.6); | Organic Amine: TEA (3.2) |
| | 1,3-butanediol (3.5) | |
| 18 | Lipophilic solvent: Esterol 123 (34.4) | Boric Acid (1.4) |
| | Surfactant: Unisol 516 (51.7) | Propionic Acid (1.9) |
| | Other: Glysolv DPM (4.0); | Organic Amine: DEANOL (2.5) |
| | 1,3-butanediol (4.0) | |
| 19 | Lipophilic solvent: Esterol 112 (34.4) | Boric Acid (1.4) |
| | Surfactant: Unisol 516 (51.7) | Propionic Acid (1.4) |
| | Other: Glysolv DPM (4.3); | Organic Amine: TEA (3.1) |
| | 1,3-butanediol (3.7) | |
| 20 | Surfactant: BL8 (29.0) | Boric Acid (1.0) |
| | | Propionic Acid (30.0) |
| | | Organic Amine: TEA (40.0) |

### Example 1

Buffering Characteristics of Compositions 1-20

In this example, Compositions 1 to 20 were added to high and low pH water to compare pH adjusting characteristics.

A stock of 4 waters, adjusted to unit pH's with NaOH or HCl as appropriate, had their pH measured after additions of 0.2%, 0.5% or 1% of each the 20 compositions. A further water was adjusted to pH 9 and contained 1 WHO hardness, wherein 1 WHO contains 342 ppm of CaCO₃. Water containing ions such as CaCO₃ are generally more difficult to adjust the pH than water free of such ions.

In the tables, a (-) means that the composition was not tested at that pH.

| initial | | | | | | | | | | | | | | | | | | | | |
|---|---|---|---|---|---|---|---|---|---|---|---|---|---|---|---|---|---|---|---|---|
| pH | 1 | 2 | 3 | 4 | 5 | 6 | 7 | 8 | 9 | 10 | 11 | 12 | 13 | 14 | 15 | 16 | 17 | 18 | 19 | 20 |

pH after addition of 0.2% of Compositions 1-20

| | | | | | | | | | | | | | | | | | | | | |
|---|---|---|---|---|---|---|---|---|---|---|---|---|---|---|---|---|---|---|---|---|
| 4 | 6.2 | 6.2 | 6.2 | 5.0 | 4.6 | 5.5 | 3.9 | 6.7 | 5.5 | 7.1 | 4.7 | 5.3 | 6.9 | 5.3 | 5.9 | 6.2 | 5.5 | 5.6 | 5.4 | 5.1 |
| 7 | 7.0 | 7.0 | 7.0 | 6.5 | 5.0 | 6.7 | 3.9 | 7.5 | 7.0 | 8.5 | 6.2 | 6.4 | 7.4 | 6.5 | 6.8 | 6.9 | 7.0 | 7.0 | 6.8 | 5.1 |
| 9 | 7.2 | 7.2 | 7.2 | — | — | 7.1 | 4.0 | 7.5 | — | — | — | — | — | — | 7.2 | 7.1 | — | — | — | 5.1 |
| 9 | 8.0 | 8.0 | 7.7 | — | — | — | 4.1 | 7.5 | 8.1 | 8.7 | 7.0 | 6.9 | 8.1 | 6.7 | 7.6 | 7.6 | 7.7 | 8.2 | 8.2 | 5.2 |
| 1WHO | | | | | | | | | | | | | | | | | | | | |
| 10 | 8.0 | 7.9 | 7.9 | 7.4 | 5.7 | 7.6 | 4.2 | 7.7 | 8.5 | 9.5 | 8.1 | 8.3 | 8.1 | 7.4 | 7.5 | 7.4 | 7.3 | 8.3 | 7.6 | 5.2 |

pH after addition of 0.5% of Compositions 1-20

| | | | | | | | | | | | | | | | | | | | | |
|---|---|---|---|---|---|---|---|---|---|---|---|---|---|---|---|---|---|---|---|---|
| 4 | 6.8 | 6.9 | 6.7 | — | — | — | 3.8 | 6.8 | 6.0 | 7.8 | 4.7 | 5.3 | 7.3 | 5.5 | 6.1 | 6.4 | 6.4 | 6.8 | 6.4 | 5.1 |
| 7 | 7.0 | 7.0 | 6.9 | — | — | — | 3.8 | 7.2 | 6.9 | 8.5 | 5.5 | 5.9 | 7.5 | 6.1 | 6.6 | 6.8 | 6.9 | 7.1 | 6.7 | 5.1 |
| 9 | 7.1 | 7.1 | 7.1 | — | — | — | 3.9 | 7.2 | — | — | — | — | — | — | 6.7 | 6.8 | — | — | — | 5.1 |
| 9 | 7.7 | 7.7 | 7.4 | — | — | — | 4.0 | 7.2 | 7.9 | 8.6 | 6.3 | 6.5 | 7.9 | 6.5 | 7.3 | 7.4 | 7.2 | 7.5 | 7.4 | 5.1 |
| 1WHO | | | | | | | | | | | | | | | | | | | | |
| 10 | 7.4 | 7.4 | 7.3 | — | — | — | 4.1 | 6.9 | 7.5 | 9.0 | 6.9 | 6.4 | 7.8 | 6.4 | 6.9 | 6.9 | 7.2 | 7.3 | 7.2 | 5.1 |

pH after addition of 1.0% of Compositions 1-20

| | | | | | | | | | | | | | | | | | | | | |
|---|---|---|---|---|---|---|---|---|---|---|---|---|---|---|---|---|---|---|---|---|
| 4 | — | — | — | 5.4 | 4.7 | — | 3.8 | 6.8 | 6.6 | 8.2 | 4.8 | 5.3 | 7.5 | 5.8 | 6.2 | 6.5 | 6.7 | 6.9 | 6.6 | 5.1 |
| 7 | — | — | — | 6.2 | 4.8 | — | 3.8 | 6.9 | 6.9 | 8.5 | 5.3 | 5.7 | 7.6 | 5.9 | 6.5 | 6.7 | 6.9 | 7.1 | 6.7 | 5.1 |
| 9 | — | — | — | — | — | — | 3.8 | 6.9 | — | — | — | — | — | — | 6.5 | 6.7 | — | — | — | 5.1 |
| 9 | — | — | — | — | — | — | 3.8 | 6.9 | 7.7 | 8.5 | 5.5 | 6.3 | 7.8 | 6.4 | 7.1 | 7.3 | 7.1 | 7.3 | 7.2 | 5.1 |
| 1WHO | | | | | | | | | | | | | | | | | | | | |
| 10 | — | — | — | 6.6 | 4.8 | — | 3.9 | 6.9 | 7.2 | 8.5 | 5.8 | 6.0 | 7.7 | 6.1 | 6.6 | 6.7 | 7.1 | 7.2 | 7.0 | 5.1 |

All of Compositions 1 to 20 demonstrated an ability to adjust pH. Most of the Compositions (1-4, 6, 8, 9, 11-20) adjusted the pH of both the high and low pH water to within the range of about 5 to 8. Higher usage rates of Compositions 1 to 20 tended to adjust the pH to a preferred pH more effectively.

Composition 5 adjusted the water to a narrow range around pH 5. Composition 7 was designed to adjust the pH of the compositions to about 4, whilst Composition 10 adjusted the pH toward about 8.5. These examples show that the adjuvant composition can be prepared to target a particular pH within the specified range. Further, the compositions with higher proportions of buffering system as per the second aspect of the invention (Compositions 7 and 20) were more effective at adjusting pH than compositions according to a first aspect of the invention. Where the agrochemical is particularly sensitive to pH then a composition according to the second aspect of the invention is preferred.

### Example 2

Glyphosate Herbicide Efficacy

In this example, adjuvant compositions according to the invention were tested for efficacy with the herbicide RoundUp CT in water at initial pH of 7 and 9.

Initial pH 7 Water

Annual ryegrass seedlings were treated with RoundUp CT and the various adjuvant compositions at 70 g and 140 g glyphosate/hectare in water initially at pH 7. The Control was not sprayed. The adjuvants were used at the rates specified.

The following table sets out the fresh weight after 14 days. The lower the fresh weight, the more effective the treatment.

Fresh weight (g/plant)

| | | |
|---|---|---|
| Treatment | 70 g a.i./ha | 140 g a.i./ha |

| | |
|---|---|
| Control | 1.595 |

| | | |
|---|---|---|
| RoundUp CT/no adjuvant | 0.252 | 0.221 |
| Composition 1 (0.5%) | 0.144 | 0.088 |
| LI-700 (0.2%) | 0.215 | 0.126 |
| Composition 7 (0.5%) | 0.230 | 0.100 |

The results show that at pH 7, the adjuvants according to the invention provided enhanced efficacy for RoundUp CT. Composition 1 which adjusted the pH to around pH 7 may be more effective than Composition 7 which adjusted to pH 4, or the acidifier adjuvant LI-700.

Initial pH 9 Water

The following mixtures containing RoundUp CT and adjuvants at 70 g and 140 g glyphosate/hectare were prepared water initially at pH 9 then left for 4 hours before spraying.

Annual rye grass seedlings were treated with the spray compositions and collected after 14 days and the fresh mean weight measured.

Fresh weight (g/plant)

| | | |
|---|---|---|
| Treatment | 70 g a.i./ha | 140 g a.i./ha |

| | |
|---|---|
| Control | 1.595 |

| | | |
|---|---|---|
| RoundUp CT/No | 0.625 | 0.256 |
| Adjuvant | | |
| Composition 1 (0.5%) | 0.321 | 0.053 |
| LI-700 (0.2%) | 0.332 | 0.108 |

Both Composition 1 and LI-700 provided significant herbicidal efficacy compared with the RoundUp CT alone showing that the buffering and acidifying characteristics of these adjuvants may be providing protection for the pesticide.

### Example 3

Glufosinate Herbicide Efficacy

In this example, adjuvant compositions according to the invention were tested for efficacy with the herbicide product BASTA which may be sensitive to low pH water. All treatments were applied at 250 g a.i./Ha and sprayed at 64 L/Ha. Adjuvants were added to the pH adjusted water before the herbicide then the mixture allowed to stand for either nil, 4 hours or overnight (16 hours) as indicated before applying to the plants (annual ryegrass 2-3 leaf stage). The time interval between mixing and spraying was chosen to allow time for any degradation of the herbicide to occur which may be associated with the non-neutral pH waters.

Results are reported as mean Fresh Weight grams per plant 12 days after treatment.

| pH of water | | | Composition 1 |
|---|---|---|---|
| (holding period) | No Adjuvant | LI-700 (0.2%) | (0.5%) |
| pH 9 (4 h) | 0.47 | 0.52 | 0.69 |
| pH 7 (nil) | 0.79 | 0.61 | 0.54 |
| pH 4 (overnight) | 0.65 | 0.71 | 0.69 |
| pH 2 (overnight) | 0.89 | 0.98 | 0.41 |

| | |
|---|---|
| Unsprayed Control | 2.22 |

There is no significant difference between the treatments at pH 9, 7 or 4. However at pH 2 the use of Composition 1 significantly increased efficacy when compared with either no adjuvant or the acidifier adjuvant LI-700 indicating that the pH adjusting characteristics of Composition 1 may be protecting the pesticide from the acidic conditions.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. An adjuvant composition having pH adjusting capabilities for use with water to be used for spraying an agrochemical, said adjuvant composition comprising:
(a) 40 to 98% by weight of the total adjuvant composition of one or more carriers selected from the group consisting of lipophilic solvents selected from the group consisting of mineral oils, vegetable oils or alkyl esters of fatty acids and mixtures thereof; surfactants; and mixtures thereof; and
(b) 2 of 60% by weight of the total adjuvant composition of a buffering system comprising:
(i) 0.1 to 10% by weight of the total adjuvant composition of boric acid;
(ii) 0.1 to 10% by weight of the total adjuvant composition of an organic carboxylic acid containing up to six carbon atoms; and
(iii) 0.2 to 50% by weight of the total adjuvant composition of an organic amine to form complexes with (i) and (ii) which are soluble in the carrier.

2. A pH adjusting composition having other adjuvant properties for use with water to be used for spraying an agrochemical is provided, said pH adjusting composition comprising:
(a) 10 to 40% by weight of the total pH adjusting composition of one or more carriers selected from the group consisting of lipophilic solvents selected from the group consisting of mineral oils, vegetable oils or alkyl esters of fatty acids and mixtures thereof; surfactants; and mixtures thereof; and
(b) 60 to 90% by weight of the total pH adjusting composition of a buffering system comprising:
(i) 0.1 to 10% by weight of the total pH adjusting composition of boric acid;
(ii) 5 to 50% by weight of the total pH adjusting composition of an organic carboxylic acid containing up to six carbon atoms; and
(iii) 0.2 to 50% by weight of the total pH adjusting composition of an organic amine to form complexes with (i) and (ii) which are soluble in the carrier.

3. The composition according to claim 1 wherein in use said composition adjusts the pH of the total agrochemical composition to raise the pH of low pH water or lower the pH of high pH water to a pH in the range of from 3.5 to 9.

4. The composition according to claim 1 wherein the carrier is a lipophilic solvent.

5. The composition according to claim 4 wherein the organic amine is selected from the group consisting of primary or tertiary dimethylamines of the structure (CH₃)₂N—R wherein R contains an alkyl group of at least 8 carbons and may contain other chemical moieties and mixtures thereof.

6. The composition according to claim 5 wherein the organic amine is selected from the group consisting of dimethylalkylamines and alkylamidoalkyldimethylamines and mixtures thereof.

7. The composition according to claim 6 wherein the organic amine is selected from the group consisting of dimethylcocoamine, oleylamidopropyldimethylamine, oleo adducts prepared from N,N-dimethylaminoethanol and mixtures thereof.

8. The composition according to claim 1 wherein the carrier is a surfactant.

9. The composition according to claim 8 wherein the organic amine is an alkanolamine.

10. The composition according to claim 9 wherein the organic amine is selected from the group consisting of mono-, di- and triethanolamine and mixtures thereof.

11. The composition according to claim 1 wherein the organic carboxylic acid is selected from the group consisting of acetic acid, propionic acid, propionic acid, malic acid, maleic acid and citric acid.

12. The composition according to claim 11 wherein the organic carboxylic acid is propionic acid.

13. The composition according to claim 1 wherein the organic amine is selected from the group consisting of alkanolamines, primary of tertiary alkylamines, fattyamines, dimethylalkylamines, alkylamidoalkyl-dimethylamines and mixtures thereof.

14. The composition according to claim 13 wherein the organic amine is selected from oleylamidopropylamine, cocoamine, oleylamine, triethanolamine, oleylamidoethanolamine, di(C10)methylamine, dimethylcocoamine and oleylpropylenediamamine.

15. The composition according to claim 8 wherein the surfactant is selected from the group consisting of sodium diisooctylsulphosuccinate, sulphated alcohol ethoxylates, alcohol ethoxylates, alkylarylethoxylates, fatty acid ethoxylates, fatty acid glycerol esters, fatty alkanolamides, fatty amine ethoxylates, fatty acid sorbitan esters, ethoxylated fatty acid sorbitan esters, alkyl polyglucosides, fatty amine oxides, fatty betaines and mixtures thereof.

16. The composition according to claim 1 wherein the vegetable oil is selected from the group consisting of medium chain triglycerides and canola, corn, sunflower and soyabean oils and mixtures thereof.

17. The composition according to claim 1 wherein the alkyl esters of fatty acids are selected from the group consisting of methyl, ethyl and butyl esters of natural oils and fats and synthetic vegetable oils and mixtures thereof.

18. The composition according to claim 17 wherein the alkyl esters of fatty acids are selected from the group consisting of methyl and ethyl esters of canola oil mixtures thereof.

19. The composition according to claim 2 wherein the pH is adjusted to a pH in the range from 5 to 8.

20. The composition according to claim 1 further comprising other solvents which improve the physical characteristics of the formulation.

21. The composition according to claim 20 wherein the other solvents are selected from the group consisting of glycols such as glycerine, hexylene glycol or 1,3-butanediol, glycol ethers such as dipropyleneglycol monomethyl ether, simple alcohols such as ethanol or isopropanol or water and mixtures thereof.

22. The composition according to claim 1 wherein the amount of boric acid is in the range from 0.5 to 5.0.

23. The composition according to claim 22 wherein the amount of boric acid is in the range from 1.0 to 3.0.

24. The composition according to claim 1 wherein the amount of organic amine is in the range from 1 to 25.

25. The adjuvant composition according to claim 1 wherein the amount of organic carboxylic acid is in the range from 0.5 to 5.0.

26. The adjuvant composition according to claim 25 wherein the amount of organic carboxylic acid is in the range from 1.0 to 3.0.

27. The pH adjusting composition according to claim 2 wherein the amount of organic carboxylic acid is in the range from 5 to 30.

28. A method for adjusting the pH of water to be used for spraying an agrochemical comprising the step of adding to the water an adjuvant composition according to claim 1.

29. A method for adjusting the pH of water to be used for spraying an agrochemical comprising the step of adding to the water a pH composition according to claim 2.

30. A buffering system for use with water to be used for spraying an agrochemical, said buffering system comprising:
(a) 0.1 to 10% by weight of boric acid;
(b) 0.1 to 50% by weight of an organic carboxylic acid containing acid up to six carbon atoms; and
(c) 0.2 to 50% by weight of an organic amine to form complexes with (a) and (b).

31. A method for adjusting the pH of water to be used for spraying an agrochemical to a pH in the range of from 3.5 to 9, said method comprising the steps of:
(a) Adding water to a tank for mixing agrochemical compositions;
(b) Adding to the tank, a buffering system comprising:
(i) 0.1 to 10% by weight of boric acid;
(ii) 0.1 to 50% by weight of an organic carboxylic acid containing up to six carbon atoms; and
(iii) 0.2 to 50% by weight of an organic amine to form complexes with (i) and (ii); and
(c) adding one or more carriers selected from the group consisting of lipophilic solvents selected from the group consisting of mineral oils, vegetable oils or alkyl esters of fatty acids and mixtures thereof; surfactants; and mixtures thereof to the tank.
